(19) United States
(12) Patent Application Publication
(10) Pub. No.: US 2006/0265729 A1
(43) Pub. Date: Nov. 23, 2006

(54) Video communication system

(76) Inventor: Richard L. Anglin JR., Del Mar, CA (US)

Correspondence Address: Thomas N. Giaccherini, Post Office Box 1146, Carmel Valley, CA, 93924, US

(21) Appl. No.: 11/433,921

(22) Filed: May 12, 2006

Related U.S. Application Data
(60) Provisional application No. 60/682,333, filed on May 17, 2005.

(51) Int. Cl. H04N 7/173

(52) U.S. Cl. 725/105

(57) ABSTRACT

The present invention comprises a central network transceiver (10) which both transmits and receives wireless radio signals. The central network transceiver (10) emits a broadcast or “point-to-multipoint” signal (12) which is received by many users or customers (14) which are located remotely from the central network transceiver (10). Customers (14) view video content using a personal computer, a modified television that includes a video camera (18), or some other video terminal or appliance (16).

### CROSS-REFERENCE TO A RELATED PROVISIONAL PATENT APPLICATION & CLAIM FOR PRIORITY

This Non-Provisional Patent Application is related to a Pending U.S. Provisional Patent Application, U.S. Ser. No. 60/682,333, which was filed on 17 May 2005.

In accordance with Sections 119 & 120 of Title 35 of the United States Code of Laws, the Applicant hereby claims priority for any subject matter which is commonly disclosed in the Pending Provisional Patent Application, and in the Present Non-Provisional Patent Application.

The title of this Non-Provisional Patent Application is Video Communication System. The Applicant is Richard L. Anglin, Jr., 2115 Heather Lane, Del Mar, Calif. 92014. The Applicant is a Citizen of the United States of America.

### FEDERALLY SPONSORED RESEARCH OR DEVELOPMENT

None.

### FIELD OF THE INVENTION

The present invention pertains to methods and apparatus for providing interactive video and audio communications using a wireless network. More particularly, one preferred embodiment of the invention furnishes an interactive communications platform that connects personal computers using a high speed wireless network.

### BACKGROUND OF THE INVENTION

Over the past decade, the Internet has expanded to serve millions of users. Many users, however, are still limited to relatively low speed (56 kbps) dial-up connections. A minority of current Internet connections offer high speed access, which ranges from a few to several hundred kilobits per second, up to 1.5 Mbps service. While these connections are usually adequate for web surfing and e-mail, they are still generally too slow to provide fully interactive video communications in realtime.

Many video conference services are currently available in the marketplace that employ DSL, satellite or cable Internet connections. At the present time, however, extremely high speed communication services that offer data rates of tens or hundreds of megabits per second or even gigabits per second are not generally available to the general public. The development of such a system would constitute a major technological advance, and would satisfy long felt needs and aspirations in the telecommunications and electronics industries.

### SUMMARY OF THE INVENTION

The present invention comprises methods and apparatus for transmitting and/or and receiving wireless radio signals. A central network transceiver emits a broadcast signal which is received by many customers which are located remotely from the central network transceiver.

In one embodiment, customers view video content using a personal computer, a modified television that includes a video camera, or some other video terminal or appliance. Each customer receives the same signal which is broadcast from the central network transceiver. Each customer may send his or her own return signal back to the central network transceiver. One or more of these return signals may be used to produce an updated broadcast video signal, which is then seen by all the customers.

In one embodiment, a digital chirp radio is used to implement the invention. In general, a chirp is a pulse, waveform or propagated signal which may be characterized by a mathematical function. In one embodiment, the mathematical function comprises a relationship between frequency and time. The invention also includes a chirp reception means for receiving chirps without the need for tuning to a carrier waveform. The reception means is capable of extracting digital data from the received chirps. In alternative embodiments of the invention, the chirps may convey voice, video or other signals.

An appreciation of the other aims and objectives of the present invention and a more complete and comprehensive understanding of this invention may be obtained by studying the following description of a preferred embodiment and by referring to the accompanying drawings.

### A BRIEF DESCRIPTION OF THE DRAWINGS

FIG. 1 shows a number of people using televisions and/or personal computers to participate in an extremely high speed interactive video and audio communication environment.

FIG. 2 offers a view of one particular embodiment of the invention, which provides this Video Communication System in the State of Alabama using a single central transmitter.

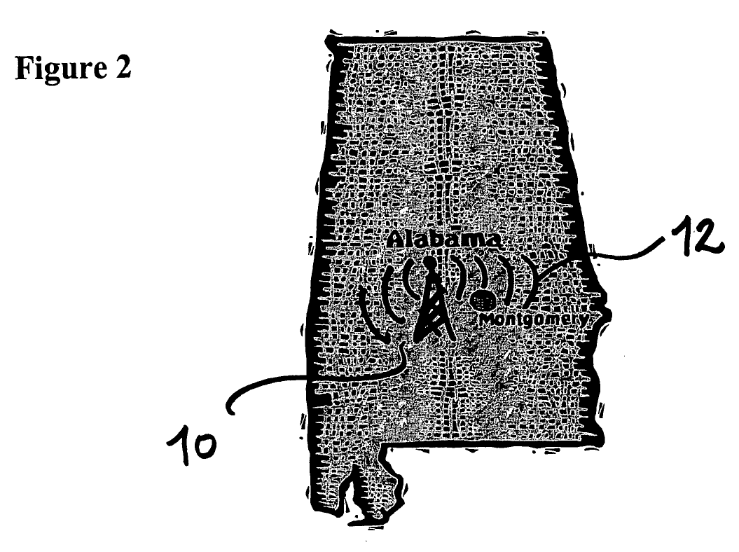

FIG. 3 offers a view of another embodiment of the invention, which incorporates more than one transmitter.

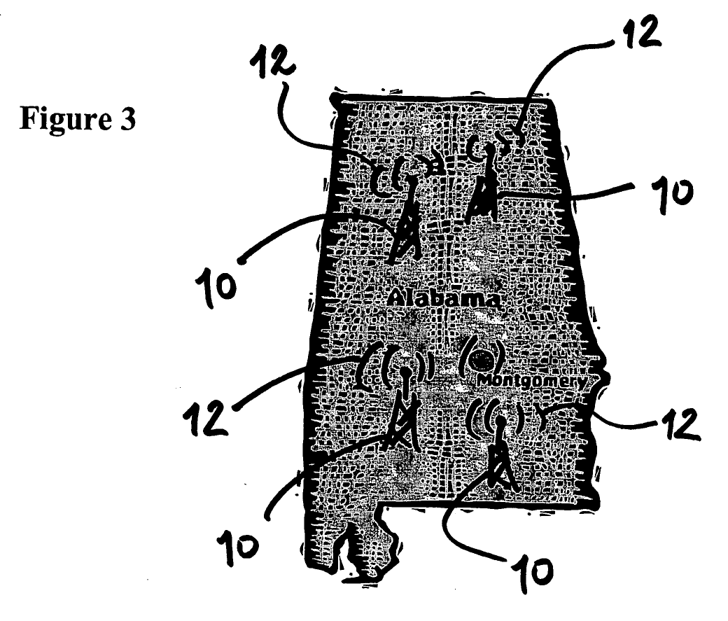

FIG. 4 is a view of a television or computer screen which displays a list of “Communication Clubs” that may be offered to users of the present invention.

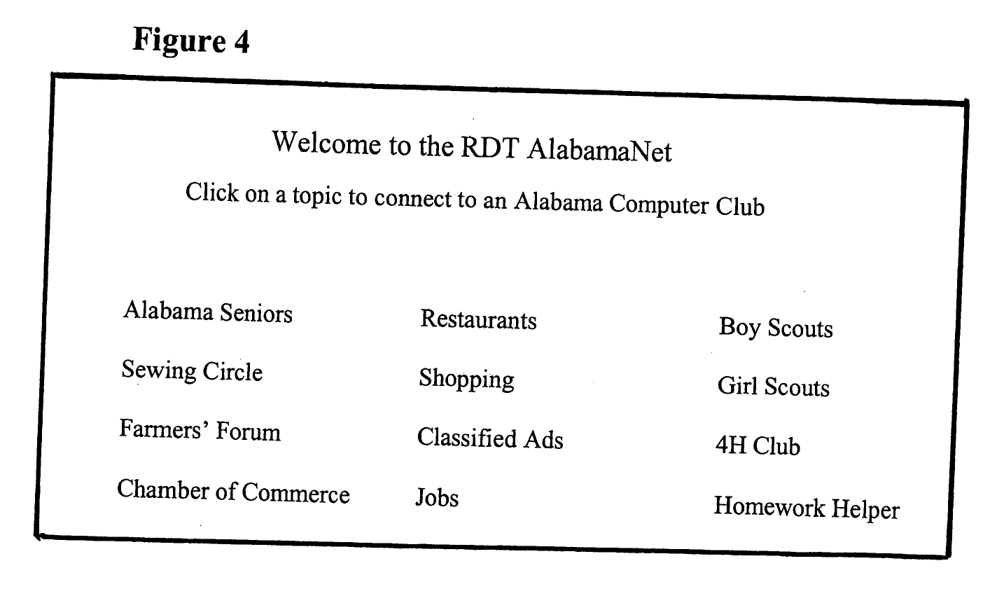

FIG. 5 is a pictorial representation of several users shown on a computer screen who are participating in one of the Communication Clubs shown in FIG. 4.

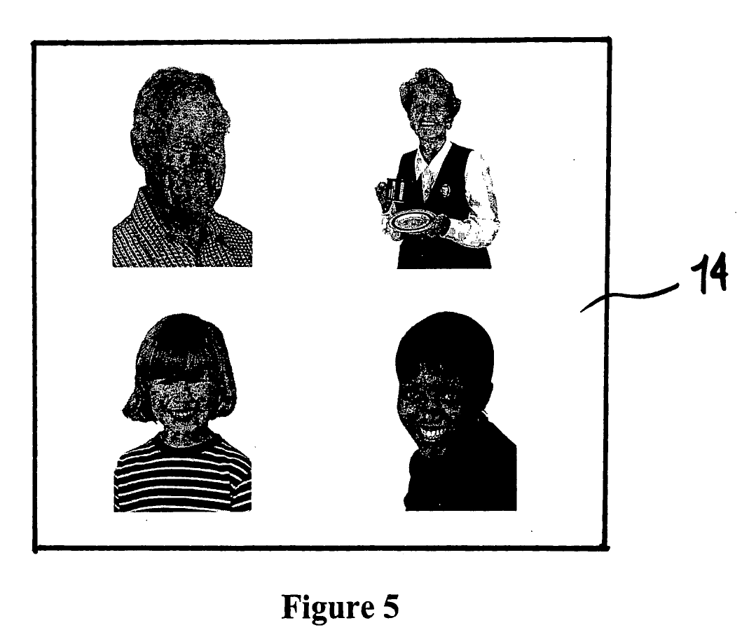

FIG. 6 is a schematic illustration of a computer monitor or television which displays a broadcast signal, and which is equipped with a video camera for producing a return signal back to the broadcaster.

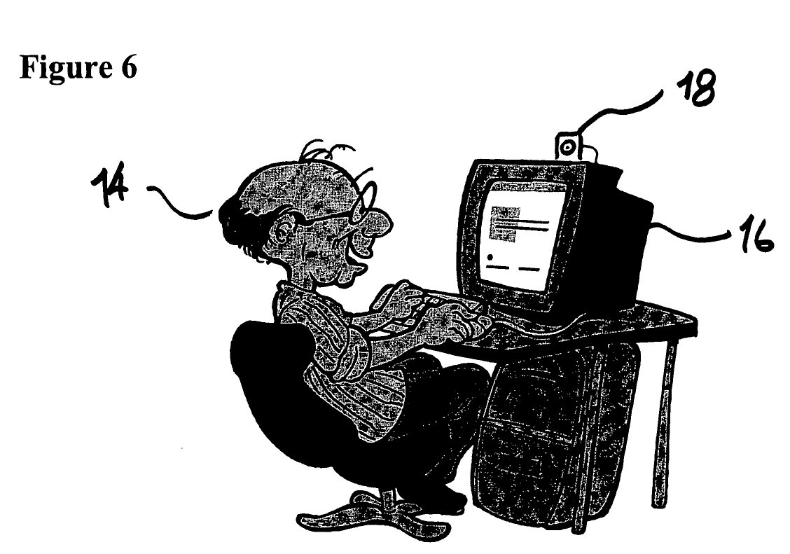

FIG. 7 shows linear frequency chirps.

FIG. 8 shows a progression of linear frequency up-chirps and down-chirps in time-frequency space.

FIG. 9 shows a progression of linear frequency up-chirps and down-chirps in time-field strength space.

FIG. 10 shows non-linear frequency chirps.

FIG. 11 shows a functional block diagram of the Chirping Digital Wireless System.

FIG. 12 shows a functional block diagram of a chirping transmitter system.

FIG. 13 shows a functional block diagram of a chirping receiver system.

### A DETAILED DESCRIPTION OF PREFERRED & ALTERNATIVE EMBODIMENTS

I. Overview of the Invention & Definitions

The present invention comprises methods and apparatus for providing extremely high speed, wireless communication links that support fully interactive video and audio platform. In one embodiment, the invention furnishes a network that connects users who are equipped with personal computers, modified televisions or other video and/or audio terminals.

In this Specification and in the Claims that follow, the term “broadcast” refers to a method of signal conveyance that propagates from a transmitter to a number of terminals in remote locations. The term “signal” may be used to encompass many forms of content, including, but not limited to, video, still images, audio, text or any other form of intelligence, data or communication. A “return” signal is generally a signal that is conveyed from a single customer terminal back to a central broadcaster without being received directly by another customer.

The present invention may be implemented using a personal or portable computer, television, cellular phone, or information appliance, or any other means for exhibiting or reproducing data.

II. A Detailed Description of the Invention

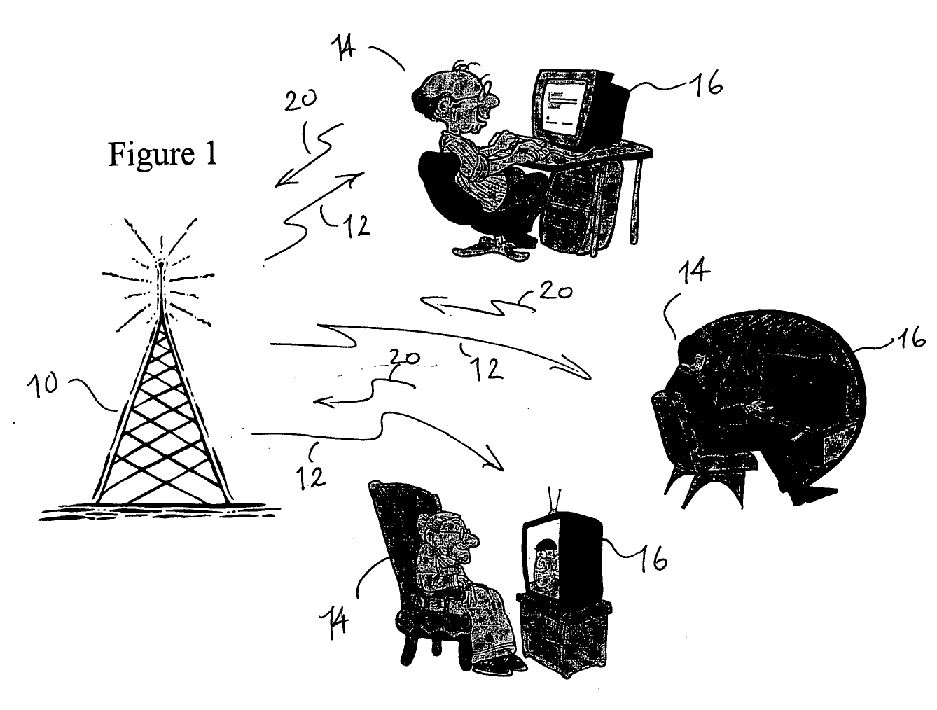

FIG. 1 shows a central network transceiver 10 which both transmits and receives wireless radio signals. The central network transceiver 10 emits a broadcast or “point-to-multipoint” signal 12 which is received by many users or customers 14 which are located remotely from the central network transceiver 10.

Customers 14 view video content using a personal computer, a modified television that includes a video camera 18, or some other video terminal or appliance 16. The customer 14 may view video content on mobile devices, such as laptop computers, cell phones or some other portable device. Each customer 14 receives the same signal 12 which is broadcast from the central network transceiver 10. Each customer 14 may send his or her own return signal 20 back to the central network transceiver 10. One or more of these return signals 20 may be used to produce an updated broadcast video signal 22, which is then seen by all the customers 14.

The compilation of a number of return signals 22 from customers 14 to continuously produce an updated broadcast video signal 22 enables a two-way, fully interactive video communication platform among many users or customers 14 who reside in many different locations. In one embodiment of the invention, this interactive video communication is accomplished with broadcast wireless signals that emanate from one or more central network transceivers 10, and with return wireless signals that are returned back to the central network transceivers 10 from customers 14. The exclusive use of wireless signals without the need for wireline, cable or fiber connections offers completely wireless video-conferencing.

III. Interactive Software

The present invention may be practiced using a variety of software programs which provide interactive audio and/or video communications among a number of customers. In one particular implementation, the invention may utilize CollabWorx™, a commercially available software package sold by CollabWorx, Inc. of Syracuse, N.Y. According to the company's website, “the CollabWorx™ Platform is a powerful, flexible Web-based collaboration framework that can be extended to quickly and easily develop solutions tailored to the business' needs. The CollabWorx™ Interactive platform enables CollabWorx™ and its partners to develop tailor-made, secure solutions for collaboration, communication and distance learning and training.” “The CollabWorxrm Platform is . . . an event-sharing technology, providing secure communications for voice, video, instant messaging, browsing, and file and application sharing. With CollabWorxm, companies can deploy either off-the-shelf or customized scalable collaboration solutions . . . ” This software package enables the present invention to offer customers “collaborative computing” a term which “describes a variety of activities where people interact with one another using desktops, laptops, palmtops, and sophisticated digital cellular phones. As computers are best at handling data and representing information, person-to-person communication is enriched by an ability to share, modify, or collaboratively create data and information.”

In one embodiment of the invention, a customer is able to view a box on the screen of their television, personal computer, personal digital appliance, cell phone or some other mobile device. The box presents the names of individuals of some selected, particular group. In addition, an icon next to each name shows whether that particular individual is currently on-line. When the user clicks on the “available” icon, a connection with that person is established with no further user input, except, perhaps, for obtaining permission to participate. The list may also include a group icon. This group icon would not indicate the readiness of entire group for participation unless and until every member changes their individual icon to “available.” Once the group icon signifies the availability of all of its members, then clicking the icon would establish the “complete” conference. In an alternative embodiment, the group icon could work independently of the individual availability via permissions. In yet another embodiment, the list would include a small calendar, which may be linked to the group icon. For example, if the Ladies' Sewing Circle Club meets every Tuesday at 10:00 a.m., the screen may present a button or icon that says “Join the Sewing Circle.” Other, different icons may be displayed for other clubs that may meet at other times, such as the Daughters of the American Revolution on Thursday afternoon.

IV. Details of a Digital Radio Method Using Chirps

Overview of the Invention

The Video Communication System may be implemented using digital “chirp” waveforms, which are described in detail in the text that follows.

A “chirp” is generally defined as a waveform or propagated signal which may be characterized by a mathematical function. In one embodiment of the invention, the mathematical function is a relationship between the frequency of the chirp and time.

The chirp interval (“T”) is defined as the time between the beginning of one chirp and the beginning of the succeeding chirp.

Impression of a digital structure to such a signal can be accomplished by defining a binary one (1) to be an up-chirp and a binary zero (0) to be a down-chirp, or vice versa. A digital signal can then be sent using a stream of up- and down-chirps.

The data rate for the digital stream is determined by the time between the start of successive chirps. Very high data rates can be achieved with today's semiconductor technology.

The receiver of the information only needs to determine if the chirp being received is up or down to determine if the signal being sent is a binary one or a binary zero. This means that a great deal of dispersion and noise can be tolerated in conjunction with the signal.

Similarly, alternative chirp forms, that is, non-linear chirps, can be used to define binary, alphanumeric or specialized characters. Multiple transmissions are thus enabled in the same waveform by using alternative chirp modes.

Dead time between the chirps is not necessary, but would allow such strategies as range and/or time gating at the receiver, for example, using differential Global Positioning System (“GPS”) for receiver location. This would eliminate the multiple path problem in urban environments and make reception of weaker and/or nosier signals more reliable.

Dead time between pulses and directional antennas also make possible broadcast of multiple signals on the same frequency band, thus increasing the potential number of communications in a particular frequency band.

Time spacing and duration of the chirps determines not only the throughput of the system but the difficulty and expense in building a wireless communications system based upon these principles. The system can initially be built with large spacing and long pulses and both can be shortened as the system matures and more throughput is required. Additionally, multiple sub-bands can be established and the chirps broadcast within the sub-bands.

The disclosed invention is fundamentally different from existing wireless communications systems. Whether analog or digital, whether coded or packetized, all existing wireless communications systems rely upon voltage pulses for the transmission of information. The disclosed invention utilizes pure frequency pulses for the transmission of information; no carrier waveform is required (although their use may be beneficial for various technical reasons).

The present invention offers a number of synergies and advantages. First, all existing two-way mobile communications technologies are narrow-band, fixed bandwidth and symmetrical, that is, out-bound and in-bound channels are of equal size. The disclosed invention can be asymmetrical, the out-bound transmission to the mobile user much higher in bandwidth than the in-bound channel. Further, the out-bound bandwidth can be variable; it can be tailored to meet service requirements. Further, both the out-bound and in-bound bandwidth can be allocated dynamically, that is, allocated in time in response to user demand. For example, more bandwidth can be allocated to download a Web page than is required to request a particular Web page.

Second, the disclosed invention can be used for reliable communications in a multipath and radio frequency (“RF”) noisy environment. Transmission integrity may be maintained in an environment of interference from other transmissions in the same frequency band.

Third, the disclosed invention provides transmission capability and capacity to multiple users within simultaneous non-interfering multiple waveforms.

Fourth, the disclosed invention enables a variety of voice, audio, data, image and compressed video services primarily to mobile users heretofore unavailable.

IV. Preferred & Alternative Embodiments

While a wide variety of radios may be employed to practice the present invention, specific preferred and alternative embodiments of radio circuitry that may be used to implement the invention are described in the text that follows.

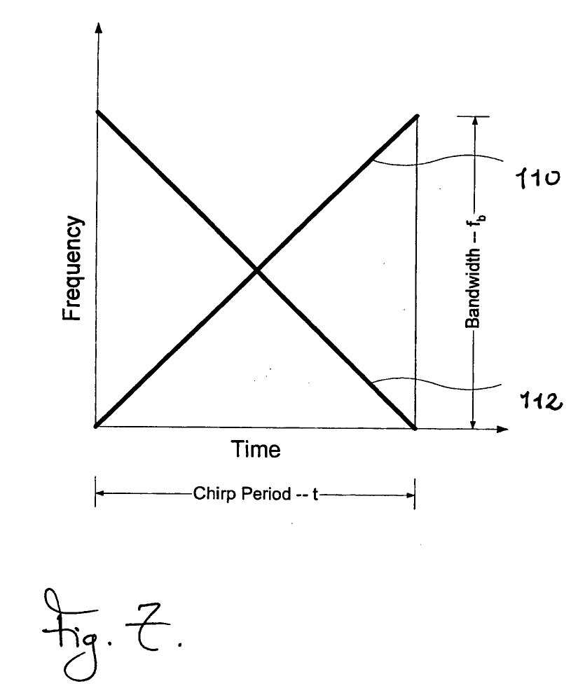

FIG. 7 shows a linear frequency up-chirp 110 and a linear frequency down- chirp 112. These chirps are defined by their bandwidth (“fb”) and chirp period (“t”)

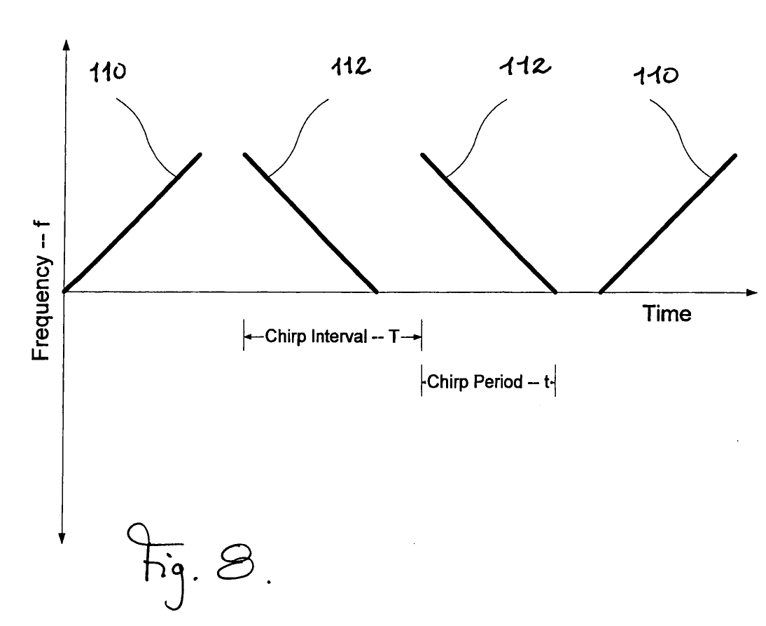

FIG. 8 shows a progression of linear frequency up-chirps 110 and down- chirps 112 in time-field strength space.

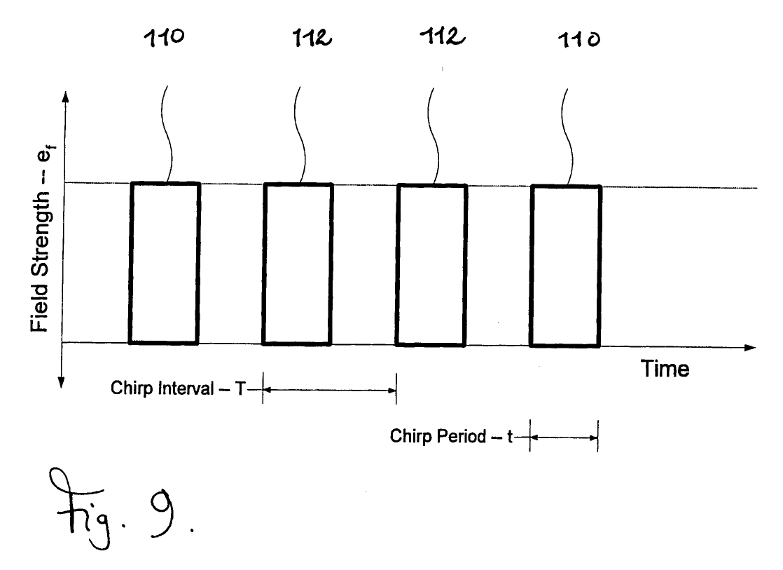

FIG. 9 shows a progression of linear frequency up-chirps 110 and down- chirps 112 in time-field strength space.

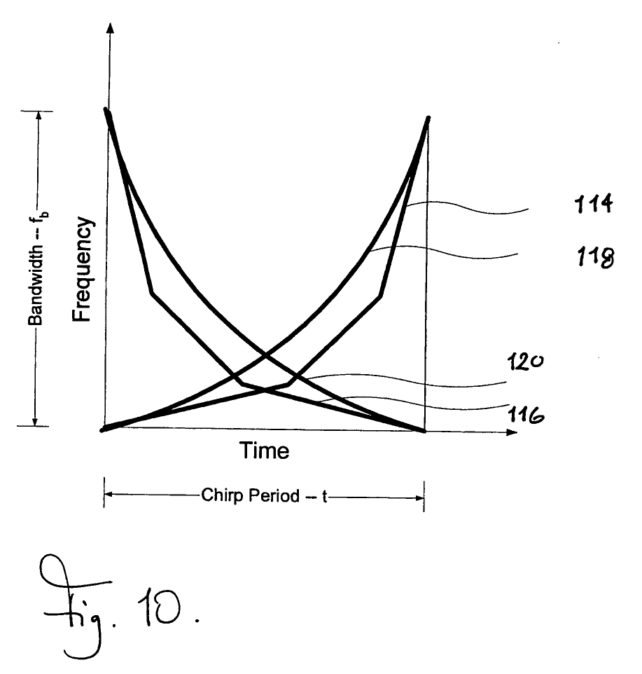

FIG. 10 illustrates non-linear frequency chirps; a linear segment frequency up-chirp 114; a linear segment frequency down-chirp 116; a curvilinear up-chirp 118; and a curvilinear down-chirp 120.

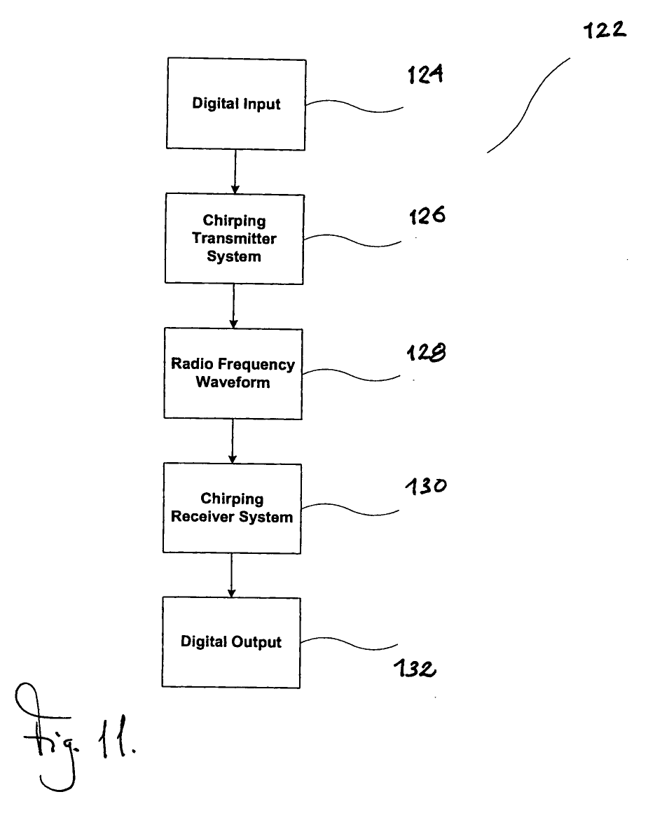

FIG. 11 shows a functional block diagram of a circuit 122 which may be utilized to implement the Video Communication System. A digital input 124 is fed to a chirping transmitter system 126 that generates the chirping radio frequency (“RF”) waveform 128. The transmitted chirping radio frequency waveform 128 is received by a chirping receiver system 130 which generates a digital output 132 that recreates the digital input 124.

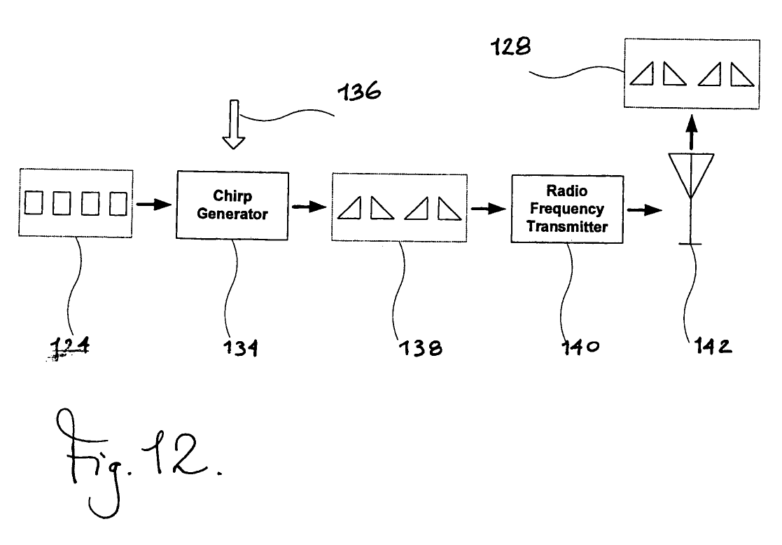

FIG. 12 shows a functional block diagram of a chirping transmitter system 126. A digital input 124 is fed to a chirp generator 134. An example of a chirp generator is a Qualcomm Incorporated Q2368 Direct Digital Synthesizer (“DDS”). However, any chirp generator may be used. A control input 136 defines the form of the chirp, its total bandwidth (fb), chirp period (t) and chirp interval (T). The output of the chirp generator 134 is a series of chirps 138 having a uniform field strength (“ef”), total chirp bandwidth (fb), chirp period (t) and chirp interval (T). The chirp output 138 is fed to a radio frequency transmitter 140 and antenna system 142. The radio frequency transmitter 140 may be a broadband or a multi-channel transmitter. The RF output 128 comprises the wireless waveform.

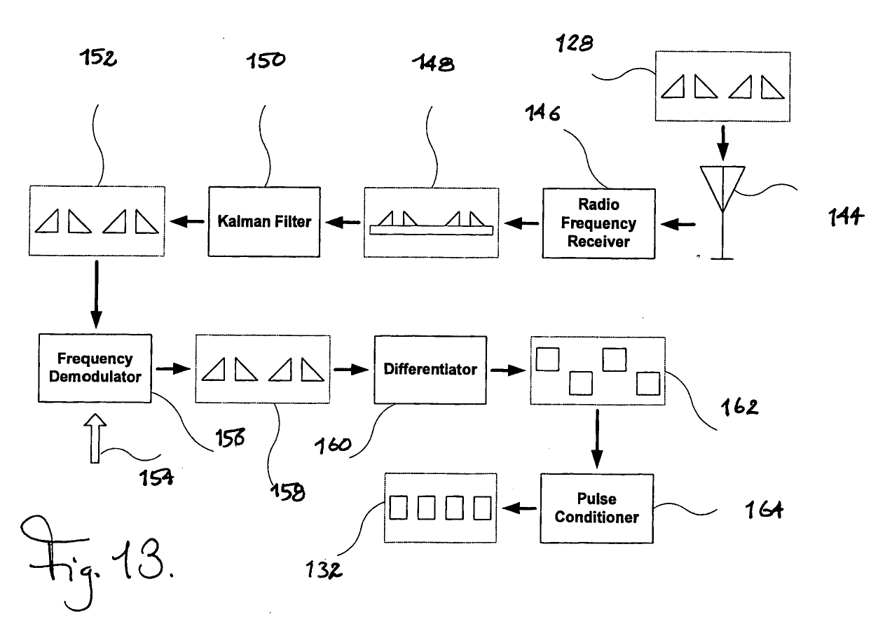

FIG. 13 shows a functional block diagram of a chirping receiver system 130. The chirping RF waveform 128 is received by an antenna 144 and RF receiver 146. The radio frequency receiver 146 may be a broadband receiver or a multi-channel receiver. The received RF input waveform 148 comprises both the RF output waveform 128 as well as RF noise resulting from the wireless transmission. The RF noise is removed from the RF input 148 using a Kahlman filter 150 resulting in a filtered RF input waveform 152. The filtered RF input waveform 152 is demodulated against a reference frequency 154 by a frequency demodulator 156. The result is an intermediate frequency (“IF”) input waveform 158 that is fed to a differentiator 160 to generate IF pulses 162 that correlate with input chirps. The IF pulses 162 are conditioned 164, that is, conformed to square wave, to yield the digital output 132.

The disclosed invention is particularly advantageous in frequency bands in which the allowed power levels are specified per frequency interval.

A further advantage of the present invention is the ability to dynamically allocate services. Another advantage of the disclosed invention is that the same digital input 124 can be simultaneously impressed on multiple RF frequencies without interfering with the information content of the digital data.

Yet another advantage of the disclosed invention is that transmission to different users may be combined in a single waveform 128 by using different chirp modes 110-120. Another advantage of the disclosed invention is that alternative chirp modes 110-120 may be used to define binary, alphanumeric and/or special characters.

A preferred embodiment of the disclosed invention 122 utilizes linear frequency chirps 110, 112.

The present invention encompasses methods and apparatus to enable efficient high bandwidth digital wireless communications. The disclosed invention can be used to provide a variety of interactive information and data services, including voice, audio, data, image and compressed video to mobile users, and also to fixed users. The disclosed invention responds to increasing mobility and demands for real-time information.

### Conclusion

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives that have been disclosed above are intended to educate the reader about preferred embodiments of the invention, and are not intended to constrain the limits of the invention or the scope of Claims.

### LIST OF REFERENCE CHARACTERS

10 Central network transceiver
12 Broadcast or “point-to-multipoint” signal from central network transceiver to users
14 Customer
16 Customer terminal
18 Video camera
20 Return point-to-point signal from customer to central network transceiver
22 Updated broadcast signal
110 Linear Frequency Up-Chirp
112 Linear Frequency Down-Chirp
114 Linear Segment Frequency Up-Chirp
116 Linear Segment Frequency Down-Chirp
118 Curvilinear Frequency Up-Chirp
120 Curvilinear Frequency Down-Chirp
122 Chirping Digital Wireless System
124 Digital Input
126 Chirping Transmitter
128 Chirping Radio Frequency Waveform
130 Chirping Receiver
132 Digital Output
134 Chirp Generator
136 Chirp Generator Control Input
138 Chirp Output
140 Radio Frequency Transmitter
142 Transmit Antenna
144 Receive Antenna
146 Radio Frequency Receiver
148 Received Radio Frequency Input Waveform
150 Kahlman Filter
152 Filtered Radio Frequency Input Waveform
154 Intermediate Reference Frequency
156 Frequency Demodulator
158 Intermediate Frequency Input Waveform
160 Differentiator
162 Intermediate Frequency Pulses
164 Pulse Conditioner

What is claimed is:

1. A method comprising the steps of:
conveying a point-to-multipoint broadcast signal (12) from a central network transceiver (10) to a plurality of remote wireless customer transceivers (16);
collecting a point-to-point return signal (20) from one of said plurality of remote wireless customer transceivers (16) at said central network transceiver (10); and
conveying an updated point-to-multipoint signal (22) from a central network transceiver (10) to said plurality of remote wireless customer transceivers (16); said updated point-to-multipoint signal (22) including said point-to-point return signal (20) from one of said plurality of remote wireless customer transceivers (16);
said updated point-to-multipoint signal (22) providing a fully-interactive wireless video communication platform for a plurality of customers (14).

2. A method as recited in claim 1, further comprising the steps of:
generating a plurality of chirps (110, 112); each of said plurality of chirps (110, 112) having a characteristic slope portion;
transmitting said plurality of chirps (110, 112) from said central network transceiver (10) without a carrier signal;
receiving said plurality of chirps (110, 112) at said remote wireless customer transceiver (16) without tuning to a carrier signal; and
extracting information from said plurality of chirps (110, 112) by reading said characteristic slope portion of each chirp (110, 112).

3. A method as recited in claim 2, in which each of said plurality of chirps is a linear frequency chirp (110,112).

4. A method as recited in claim 2, in which each of said plurality of chirps is a non- linear frequency chirp (114-120).

5. A method as recited in claim 2, in which said information is digital data.

6. A method as recited in claim 2, in which said information is a voice signal.

7. A method as recited in claim 2, in which said information is an audio signal.

8. A method as recited in claim 2, in which said information is video signal.

9. A propagated signal comprising:
a plurality of chirps (110, 112);
said plurality of chirps (110, 112)each conveying an element of information as characterized by the slope of one portion of each of said plurality of chirps (110, 112);
said plurality chirps (110, 112) being capable of being received without the need for tuning to a carrier waveform.

10. A method as recited in claim 2, in which allowed power levels are specified per frequency interval.

11. A method as recited in claim 2, in which services are dynamically allocated.

12. A method as recited in claim 2, in which the same digital input is simultaneously impressed on multiple RF frequencies without interfering with the information content of the digital data.

13. A method as recited in claim 2, in which transmission to different users may be combined in a single waveform by using different chirp modes.

14. A method as recited in claim 2, in which alternative chirp modes are used to define binary characters.

15. A method as recited in claim 2, in which alternative chirp modes are used to define alphanumeric characters.

16. A method as recited in claim 2, in which alternative chirp modes are used to define special characters.

17. A method as recited in claim 2, in which said remote wireless customer transceiver (16) is a mobile device.
